(19) United States
(12) Patent Application Publication
(10) Pub. No.: US 2011/0052865 A1
(43) Pub. Date: Mar. 3, 2011

(54) STRUCTURED PERFORATED PLASTIC SHEET

(76) Inventor: Chen-Cheng Huang, Taipei City (TW)

(21) Appl. No.: 12/915,306

(22) Filed: Oct. 29, 2010

Related U.S. Application Data
(63) Continuation-in-part of application No. 12/050,262, filed on Mar. 18, 2008.

(30) Foreign Application Priority Data
Mar. 19, 2007 (TW) 096109332

(51) Int. Cl. B32B 3/10

(52) U.S. Cl. 428/137

(57) ABSTRACT

A structured perforated plastic sheet includes a plastic sheet body having bottom ribs in a bottom layer, middle ribs in a middle layer, and top ribs in a top layer. The top ribs are interconnected to define a top hole. The middle ribs divide the top hole into multiple middle holes. The bottom ribs divide each middle hole into multiple bottom holes. Each of the top, middle and bottom ribs has a top wall and two side walls extending downwardly from two opposite sides of the top wall. The side walls of the top and middle walls are deflected in a plane of the top walls of the bottom ribs.

### CROSS-REFERENCE TO RELATED APPLICATION

This application is a continuation-in-part of U.S. application Ser. No. 12/050,262, filed on Mar. 18, 2008.

### TECHNICAL FIELD

This invention relates to a structured perforated plastic sheet, more particularly to a structured perforated plastic sheet having a tri-layer configuration.

### BACKGROUND OF THE INVENTION

U.S. Patent Application Publication No. 20040043189 discloses a structured perforated plastic sheet that can be used as a wearer-contacting top sheet of an absorptive device, such as a diaper or bandage, a water-retaining material for agricultural applications, a sanitary napkin, or a packaging or a decorative material. The structured perforated plastic sheet has a bi-layer configuration including a top layer of a net-like structure and a bottom layer of a net-like structure. The net-like structure of the top layer defines a plurality of top holes. The net-like structure of the bottom layer defines a plurality of bottom holes. Each of the top holes has an area much larger than that of each of the bottom holes, and overlies plural ones of the bottom holes. The net-like structure of the top layer can serve to break a liquid body into smaller portions and distribute them among the top holes, thereby enhancing distribution of the liquid among the bottom holes.

Referring to FIG. 1, U.S. Pat. No. 5,514,105 discloses a structured perforated plastic sheet. The structured perforated plastic sheet has a plurality of uppermost capillary openings 810, each of which is defined by a polygonal opening-defining wall 81. The polygonal opening-defining wall 81 of each of the uppermost capillary openings 810 is defined by a multiplicity of intersecting primary fiber-like elements 811. Each of the uppermost capillary openings 810 is subdivided into smaller middle capillary openings 820 by a secondary fiber-like element 821. One of the middle capillary openings 820 is further subdivided into smaller lower capillary openings 830 by a third fiber-like element 831. The lowest ends of the primary fiber-like elements 811 are coplanar with the lowest end of the secondary fiber-like element 821 and the lowest end of the third fiber-like element 831. The polygonal opening-defining wall 81 has four side walls 815. Each of the four side walls 815 has an inclined portion 8151 and a straight vertical portion 8152 extending downwardly and bent from the inclined portion 8151. The third fiber-like element 831 meets the straight vertical portion 8152 of one of the four side walls 815 of the polygonal opening-defining wall 81. The straight vertical portion 8152 of each of the four side walls 815 extends from the inclined portion 8151 to a lowest end of the side wall 815 along a linear direction without any deflection or bending except at the interfaces where it meets the second fiber-like element 821 and the third fiber-like element 831.

### SUMMARY OF THE INVENTION

An object of the present invention is to provide a structured perforated plastic sheet that can further enhance distribution of a liquid body and thereby promote transport of the liquid body and that can exhibit a tri-layered configuration.

Accordingly, a structured perforated plastic sheet comprises a plastic sheet body including a network of interconnected cells. The network has a bottom layer, a middle layer higher than the bottom layer, and a top layer higher than the middle layer. The top layer includes a plurality of top ribs that are interconnected to form a loop and to define a top hole. Each of the top ribs has a top wall and two side walls extending downwardly from two opposite sides of the top wall. The side wall of each of the top ribs has a lowest end. The middle layer includes a plurality of middle ribs disposed below the top walls of the top ribs within the top hole and meet respectively the side walls of the top ribs to divide the top hole into a plurality of middle holes. Each of the middle ribs has a top wall and two opposite side walls extending downwardly from two opposite sides of the top wall of the middle ribs and has lowest ends, respectively. The bottom layer includes a plurality of bottom ribs that are formed within and divide each of the middle holes into a plurality of bottom holes. Each of the bottom ribs has a top wall, and two opposite side walls that extend downwardly and respectively from two opposite sides of the top wall of the bottom rib. Each of the side walls of the top and middle ribs starts to deflect in a plane of the top walls of the bottom ribs, and having a bottom rib-connecting part that is sidewisely connected to the bottom ribs, that extends from the plane of the top walls of the bottom ribs to a plane of the lowest ends of the top and middle ribs, and that bends from a remaining part of a corresponding one of the side walls of the top and middle ribs. The side walls of the top and middle ribs have bending lines that cooperatively form a plurality of loop-shaped bending lines each extending around one of the middle holes in the plane of the top walls of the bottom ribs.

### BRIEF DESCRIPTION OF THE DRAWINGS

In drawings which illustrate embodiment of the invention:

FIG. 1 is a fragmentary perspective view of a conventional structured perforated plastic sheet;

FIG. 2 is a fragmentary schematic top view of the first preferred embodiment of a structured perforated plastic sheet according to this invention;

FIG. 3 is a fragmentary perspective view of the first preferred embodiment;

FIG. 4 is a fragmentary perspective view of the second preferred embodiment of a structured perforated plastic sheet according to this invention;

FIG. 5 is a fragmentary sectional view of the second preferred embodiment;

FIG. 6 is a photo image showing the tri-layer configuration of the third preferred embodiment of the structured perforated plastic sheet according to this invention;

FIG. 7 is a photo image showing the tri-layer configuration of the fourth preferred embodiment of the structured perforated plastic sheet according to this invention;

FIG. 8 is a schematic view illustrating a stacked structure of an embossing mold that can be used to make the second preferred embodiment of this invention;

FIG. 9 is a schematic view illustrating how an outward deflection occurs in a side wall of a top rib of a top layer of a structured plastic sheet due to the stacked structure of the embossing mold of FIG. 8; and

FIG. 10 is a schematic view illustrating how an inward deflection occurs in a side wall of a top rib of the structured plastic sheet due to the stacked structure of the embossing mold of FIG. 8.

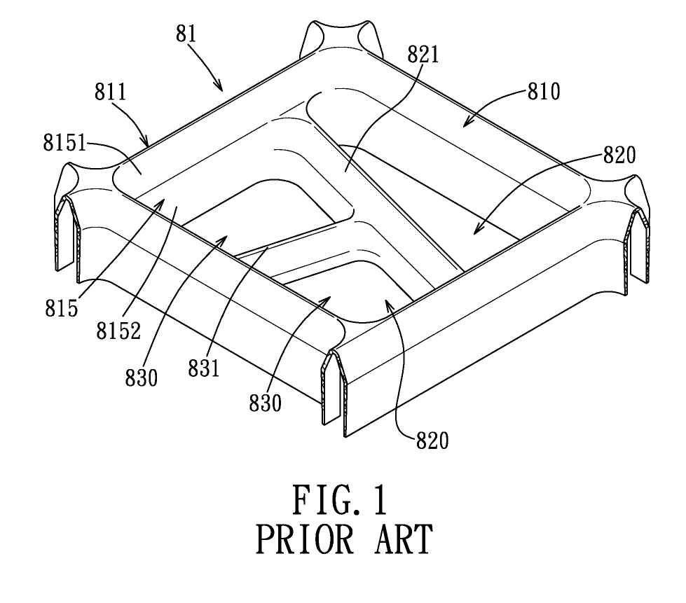

### DETAILED DESCRIPTION OF THE PREFERRED EMBODIMENT

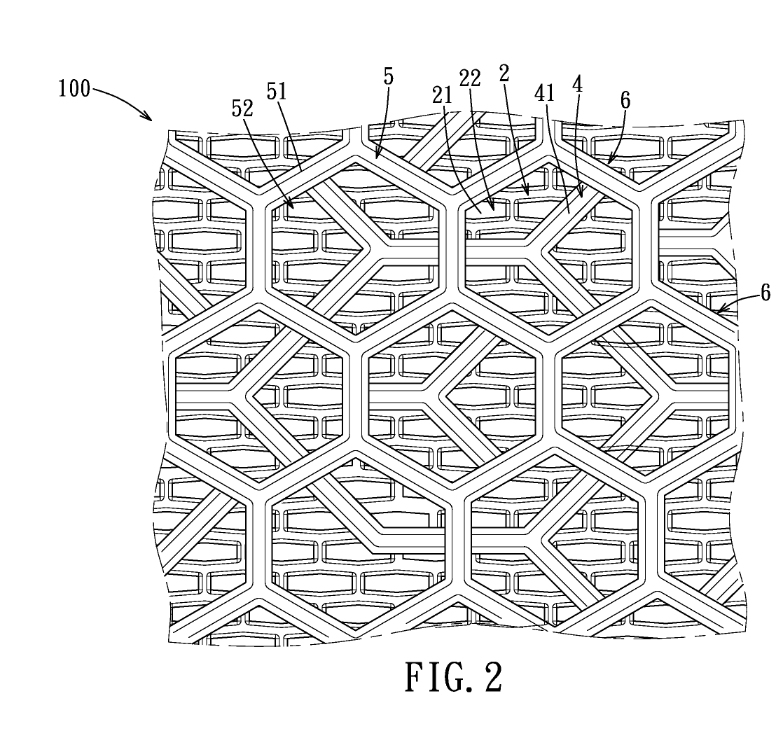

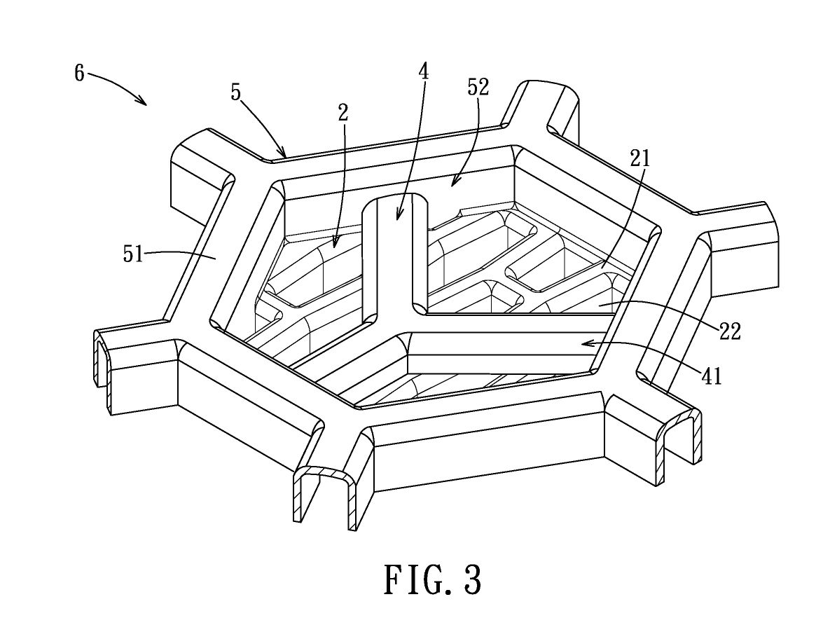

FIGS. 2 and 3 illustrate the first preferred embodiment of a structured perforated plastic sheet according to this invention. The structured perforated plastic sheet can be used as a wearer-contacting top sheet of an absorptive device, such as a diaper and bandage, or as a water-retaining material for agricultural applications, a sanitary napkin, a packaging or decorative material. The structured perforated plastic sheet includes a plastic sheet body 100 having a tri-layer configuration that includes a network of interconnected cells 6. The network includes a planar top layer 5, a planar middle layer 4, and a planar bottom layer 2 that is disposed below the middle layer 4. The top layer 5 is formed with a pattern of top holes 52, each of which is defined by a plurality of top ribs 51 that are interconnected to form a polygonal loop and to define one of the top holes 52. The middle layer 4 includes a plurality of middle ribs 41. The bottom layer 2 is formed with a pattern of bottom holes 22, each of which is defined by a plurality of bottom ribs 21 to form a polygonal loop and to define one of the bottom holes 22. Each of the middle ribs 41 meets adjacent ones of the top ribs 51. The tri-layer configuration of the plastic sheet body 100 is capable of breaking a liquid body (not shown) into smaller portions through the top, middle and bottom layers 5, 4, 2, thereby enhancing distribution and transport of the liquid body from the top layer 5 to the bottom layer 2.

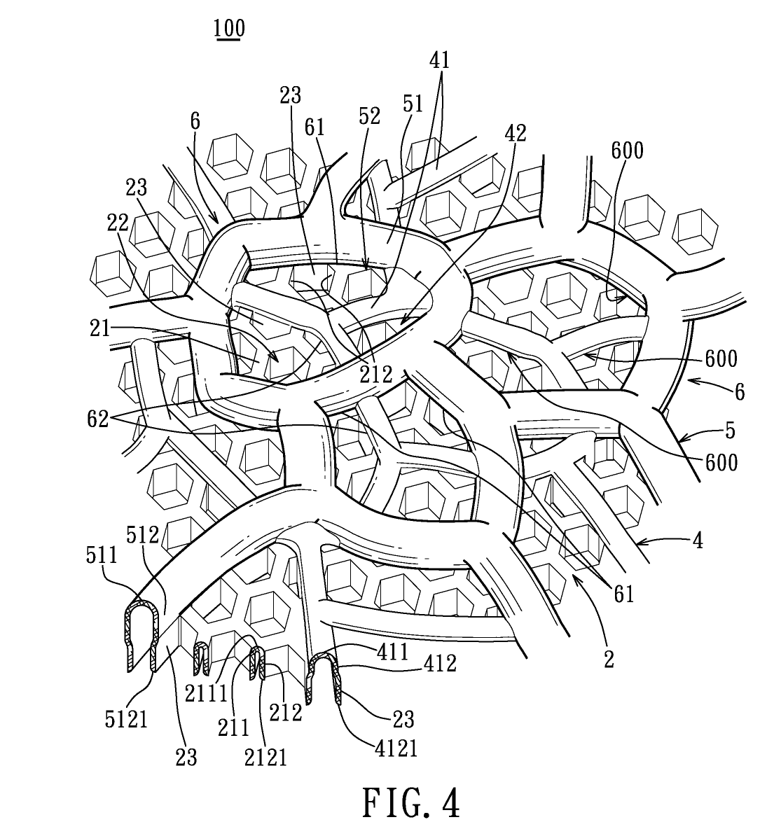

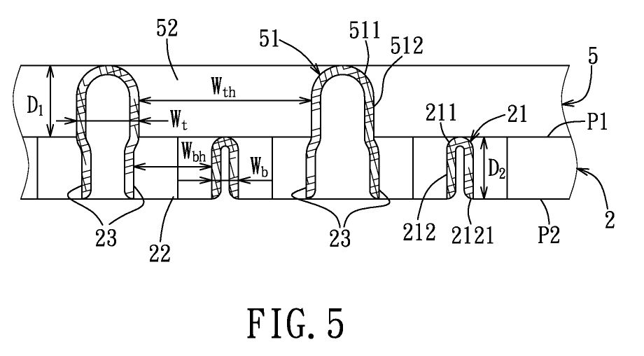

FIGS. 4 and 5 illustrated the second preferred embodiment of a structured perforated plastic sheet according to this invention. The structured perforated plastic sheet comprises a plastic sheet body 100 including a network of interconnected cells 6, which has a bottom layer 2, a middle layer 4 superimposed on and integrally formed with the bottom layer 2, and a top layer 5 superimposed on and integrally formed with the bottom layer 2. The top layer 5 includes a plurality of top ribs 51 that are interconnected to form a loop and to define a top hole 52 for each cell 6. Each of the top ribs 51 has a top wall 511 and two side walls 512 extending downwardly from the top wall 511. Each side wall 512 of each top rib 51 has a lowest end 5121. The middle layer 4 includes a plurality of middle ribs 41. The middle ribs 41 for each cell 6 are disposed below the top walls 512 of the top ribs 51 within the top hole 51 and meet respectively the side walls 512 of the top ribs 51 to divide the top hole 52 into a plurality of middle holes 42. Each of the middle ribs 41 has a top wall 411 and two opposite side walls 412 extending downwardly from two opposite sides of the top wall 411 of the middle ribs 41 and having lowest ends 4121, respectively. The bottom layer 2 includes a plurality of bottom ribs 21 that have lowest ends 2121. The bottom ribs 21 for each cell 6 divide each of the middle holes 42 into a plurality of bottom holes 22. Each of the bottom ribs 21 has a top wall 211 and two opposite side walls 212 extending downwardly and respectively from two opposite sides of the top wall 211 of the bottom rib 21.

Each side wall 512 of the top rib 51 starts to deflect in a plane (P1) (see FIG. 5) of the top walls 211 of the bottom ribs 21, and thus has a bottom rib-connecting part 23 that is connected to the bottom ribs 21, that extends from the plane (P1) of the top walls 211 of the bottom ribs 21 to the plane (P2) of the lowest ends 5121, 4121, 2121 of the top, middle and bottom ribs 51, 41, 21 and that bends from a remaining part of the corresponding side wall 512. Each side wall 412 of the middle rib also starts to deflect in the plane (P1) of the top walls 211 of the bottom ribs 21 and thus has a bottom rib-connecting part 23 that is connected to the bottom ribs 21, that extends from the plane (P1) of the top walls 211 of the bottom ribs 21 to the plane (P2) of the lowest ends 5121, 4121, 2121 of the top, middle and bottom ribs 51, 41, 21 and that bends from the remaining part of the corresponding side wall 412. Therefore, the side walls 512, 412 of the top and middle ribs 51, 41 respectively have bending lines 61, 62 which cooperatively form a plurality of looped bending lines 600 each extending around one of the middle holes 42 in the plane (P1) of the top walls of the bottom ribs 21. How the side walls 512, 412 of the top and middle ribs 51, 41 deflect will be explained hereinafter.

The number of the bottom holes 22 in each of the cells 6 is greater than 3 and less than 15 so as to achieve a higher fluid distribution and flow as well as a sufficient mechanical strength to support the cell structure of each cell 6. A hole area rate is defined hereinafter as the total area of the holes in a unit area of the plastic sheet divided by the unit area of the plastic sheet and multiplied by 100%. Preferably, the hole area rate of the bottom holes 22 ranges from 20% to 40%, while the hole area rate of the top holes 52 ranges from 65% to 85%.

Each of the top ribs 51 defines a depth (D₁) from the top wall 511 of the top rib 51 to the plane (P1) of the top walls 211 of the bottom ribs 21. The depth (D₁) is preferably greater than 0.3 mm and less than 1.5 mm. Each of the bottom ribs 21 defines a second depth (D₂) from the top wall 211 of the bottom rib 21 to the lowest end 2121 thereof. The ratio of the first depth (D₁) to the second depth (D₂) preferably ranges from 1:1 to 1:3.

The two side walls 512 of each of the top ribs 51 define a width (Wₜ) that is preferably greater than 0.15 mm and less than 2.0 mm.

The side walls 212 of each of the bottom ribs 21 define a width (W_{b}) that is preferably greater than 0.15 mm and less than 1.0 mm.

Each of the top holes 52 preferably has a minimum width (Wₜₕ) greater than 2 mm and less than 30 mm.

Each of the bottom holes 22 preferably has a minimum width (W_{bh}) greater than 0.1 mm and less than 10 mm.

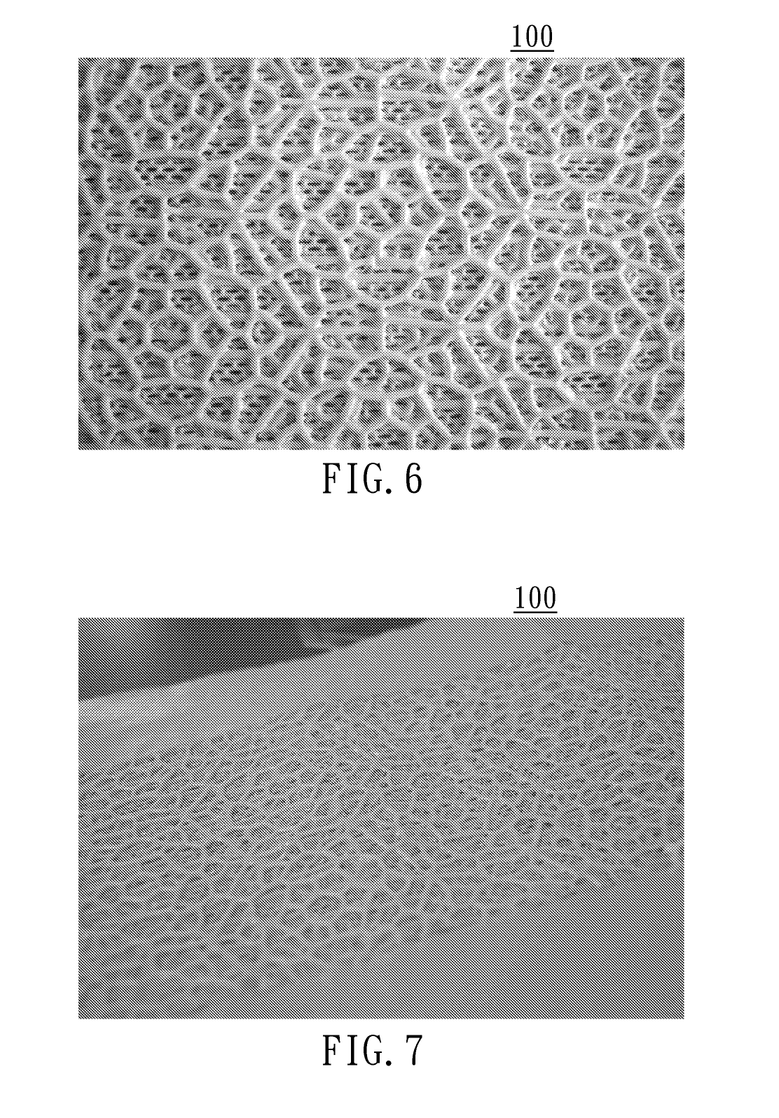

FIGS. 6 and 7 are photo images to illustrate the tri-layer configurations of the third and fourth preferred embodiments of the structured perforated plastic sheet of this invention, respectively.

A process of making the structured perforated plastic sheet according to the present invention includes: providing an embossing mold; and embossing and perforating a plastic sheet by using the embossing mold to emboss the plastic sheet and by applying heat and vacuum pressure to the plastic sheet while the plastic sheet is being embossed.

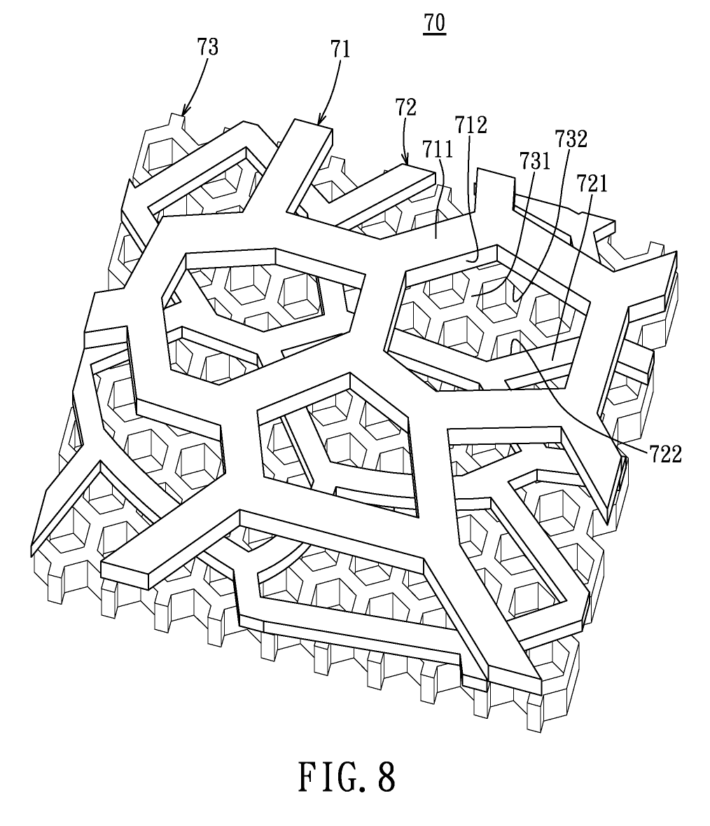

FIG. 8 illustrates a preferred embodiment of an embossing mold 70 for forming the structured perforated plastic sheet of the second preferred embodiment. The embossing mold 70 includes first, second and third screen molds 71, 72, 73 that are stacked one above the other for forming the tri-layer configuration of the structured perforated plastic sheet. The first, second and third screen molds 71, 72, 73 have different hole patterns.

The first screen mold 71 has a plurality of interconnected first looped members 711 respectively bounding first screen holes 712. The second screen mold 72 has a plurality of interconnected second looped members 721 respectively bounding second screen holes 722 and disposed below the first screen holes 712. The third screen mold 73 has a plurality of interconnected third looped members 731 respectively bounding third screen holes 732 and disposed below the second screen holes 722. Each second looped member 721 spans over a group of the third looped members 731. Each of the first screen holes 712 overlaps a group of the second screen holes 722 such that the second looped members 721 are out of alignment with the first looped members 711. The second screen mold 72 has no looped member that is aligned with the first looped member 711 and the third looped member 731 and that corresponds in shape and position to the first and third looped members 711, 731. The third screen mold 73 also has no looped member that is aligned with the first looped member 711 and the second looped member 721 and that corresponds in shape and position to the first and second looped members 711, 721.

In use, the assembly of the first, second and third screen molds 71, 72, 73 is mounted on a vacuum forming drum (not shown) which is heated and is vacuumed inside to provide a suction force to the assembly of the first, second and third screen molds 71, 72, 73. When the plastic sheet (not shown) is advanced to the vacuum forming drum, the plastic sheet is softened and embossed under vacuum pressure so that the plastic sheet is formed into the top, middle and bottom ribs 51, 41, 21 together with the top, middle and bottom holes 52, 42 and 22.

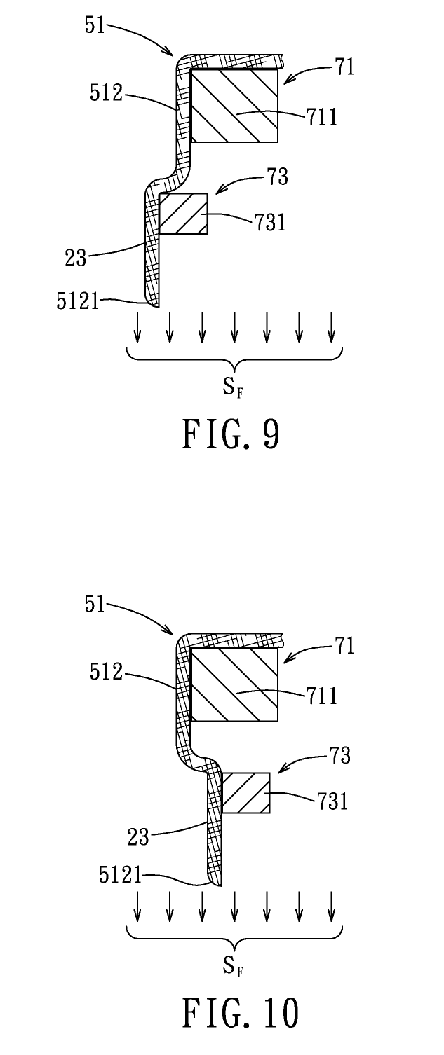

Referring to FIGS. 9 and 10 in combination with FIGS. 4 and 8, the top rib 51 in a region of the structured perforated plastic sheet is formed by the first looped member 711 of the first screen mold 71 and the third looped member 731 of the third screen mold 73. Because the third looped member 731 is not aligned with the first looped member 711, when a suction pressure (S_{F}) is applied in a downward direction as indicated by arrows in FIGS. 9 and 10, the side wall 512 of the top rib 51 starts to deflect in the plane (P1) (FIG. 5) of the top walls 211 of the bottom ribs 21. The deflection may be outward (FIG. 9) or inward (FIG. 10). In a likewise manner, deflections also occur in the middle ribs 41 because the second looped members 721 are out of alignment with the third looped members 731.

With the multi-layer configuration of the structured perforated plastic sheet of this invention, distribution and transport of a liquid body can be enhanced.

With the invention thus explained, it is apparent that various modifications and variations can be made without departing from the spirit of the present invention. It is therefore intended that the invention be limited only as recited in the appended claims.

What is claimed is:

1. A structured perforated plastic sheet comprising:
a plastic sheet body including a network of interconnected cells, each of said cells having a bottom layer, a middle layer higher than said bottom layer, and a top layer higher than said middle layer, said top layer including a plurality of top ribs that are interconnected to form a loop and to define a top hole, each of said top ribs having a top wall and two side walls extending downwardly from two opposite sides of said top wall, said side wall of each of said top ribs having a lowest end, said middle layer including a plurality of middle ribs disposed below said top walls of said top ribs within said top hole and meeting respectively said side walls of said top ribs to divide said top hole into a plurality of middle holes, each of said middle ribs having a top wall and two opposite side walls extending downwardly from two opposite sides of said top wall of said middle ribs and having lowest ends, respectively, said bottom layer including a plurality of bottom ribs that are formed within and divide each of said middle holes into a plurality of bottom holes, each of said bottom ribs having a top wall, and two opposite side walls that extend downwardly and respectively from two opposite sides of said top wall of said bottom rib, each of said side walls of said top and middle ribs starting to deflect in a plane of said top walls of said bottom ribs, and having a bottom rib-connecting part that is sidewisely connected to said bottom ribs, that extends from said plane of said top walls of said bottom ribs to a plane of said lowest ends of said top and middle ribs, and that bends from a remaining part of a corresponding one of said side walls of said top and middle ribs, said side walls of said top and middle ribs having bending lines that cooperatively form a plurality of loop-shaped bending lines each extending around one of said middle holes in said plane of said top walls of said bottom ribs.

2. The structured perforated plastic sheet of claim 1, wherein each of said top ribs defines a first depth from said top wall of said top rib to said plane of said top walls of said bottom ribs, each of said bottom ribs defining a second depth from said top wall of said bottom rib to said plane of said lowest ends of said top, middle and bottom ribs, the ratio of the first depth to the second depth ranging from 1:1 to 1:3.
